(19) United States
(12) Patent Application Publication
(10) Pub. No.: US 2026/0236908 A1
(43) Pub. Date: Aug. 13, 2026

(54) SECURE BLOCKCHAIN WALLET GENERATION BASED ON MULTI-PARTY COMPUTATION

(71) Applicant: Circle Internet Financial LTD

(72) Inventors: Chung-Tsai SU, New Taipei City (TW); Huai Ting HUANG, Taipei (TW); Jian Qiang ZHANG, TaiChung City (TW)

(21) Appl. No.: 19/047,692

(22) Filed: Feb. 7, 2025

(51) Int. Cl. G06Q 20/36; G06Q 20/38; G06Q 20/40

(52) U.S. Cl. CPC G06Q 20/367; G06Q 20/389; G06Q 20/401

(57) ABSTRACT

Certain aspects provide techniques for securely generating wallets for transactions on a blockchain. An example method generally includes receiving, at a first node, a request to generate a wallet on a blockchain. A first private share associated with the first node is generated for the wallet. A salted second private share for the wallet is received from a second node. Generally, the salted second private share is associated with a shared salt shared by the first node and at least the second node. A chain code associated with wallets generated by the first node is generated based on the first private share and the salted second private share. A wallet is generated based at least on the chain code. Generally, the wallet is defined based on wallet private shares for signing transactions on the blockchain and a wallet public key for verifying transactions on the blockchain.

### INTRODUCTION

Aspects of the present disclosure relate to security in blockchain systems, and more specifically to wallet security in blockchain systems.

### BACKGROUND

Blockchains can be used in various decentralized systems to provide a ledger of transactions that have occurred within these decentralized systems. Generally, a blockchain may include a chain of blocks, in which latest block includes some information about a transaction that occurred and a reference to an immediate predecessor block, which may be a hashed value of the previous block. Because the reference to the immediate predecessor block may be a value derived from the immediate predecessor block, verification of the transactions in the blockchain may be performed by ensuring that a hash of a block resolves to the same value as that stored as a reference to the immediate predecessor block in a succeeding block in the blockchain. If there is a mismatch between a computed hash of a block and the hashed value of the block in a succeeding block in the blockchain, validation of the blockchain may fail.

To perform transactions on a blockchain system, wallets are generally established for users in order to hold and transfer assets on the blockchain. Generally, wallets on the blockchain are defined based on a private key and a corresponding public key. The public key allows for other users to transfer assets to the wallet. Meanwhile, the private key allows the owner of the wallet to access the contents of the wallet and initiate transactions on the blockchain (e.g., to transfer assets to another wallet, to withdraw assets from the wallet to another blockchain or an external source, etc.).

Generally, preventing malicious actions from being taken in respect of a wallet involves maintaining secrecy around the data used to generate the private key associated with a wallet. Various techniques can be used to protect a private key; however, these techniques may involve various weaknesses that can be exploited to allow for a wallet private key to be recovered. For example, recovery phrases associated with a wallet private key may be used to recover the private key for a wallet; however, because of the length of these recovery phrases, users often copy these phrases and store the copy of these phrases in insecure locations which can be easily accessed. In turn, because recovery phrases can often be easily accessed, the security of a wallet and the contents therein may be compromised. In another example, users may store the private keys for wallets in insecure locations, or locations that are nominally secure but for which the security mechanisms are easily broken,

Accordingly, techniques are needed to allow for secure generation of wallets in blockchain systems.

### BRIEF SUMMARY

Certain embodiments provide a computer-implemented method for securely generating wallets for transactions on a blockchain by a node participating in a multi-party computation scheme. An example method generally includes receiving, at a first node, a request to generate a wallet on a blockchain. A first private share is generated for the wallet, the first private share being associated with the first node. A salted second private share for the wallet is received from a second node. Generally, the salted second private share is associated with a shared salt shared by the first node and at least the second node in a multi-party key generation scheme. A chain code associated with wallets generated by the first node is generated based on the first private share and the salted second private share. A wallet is generated based at least on the chain code. Generally, the wallet is defined based on wallet private shares for signing transactions on the blockchain and a wallet public key for verifying transactions on the blockchain.

Certain embodiments provide a computer-implemented method for securely generating wallets for transactions on a blockchain by a management service in a multi-party computation scheme. An example method generally includes receiving, from a first node in a multi-party key generation scheme, a request for a wallet. Generally, the request includes at least a public key and a chain code associated with the first node. The public key and the chain code may be calculated based on a first private share associated with the first node, a second private share associated with a second node, and a shared salt. A master key is retrieved based on the public key and the chain code. A wallet is generated based on the master key and the chain code, and the wallet is deployed for use on the blockchain.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example computing environment in which a wallet used for transactions on a blockchain is generated by nodes participating in a multi-party computation scheme, according to aspects of the present disclosure.

FIG. 2 depicts an example computing environment in which a wallet used for transactions on a blockchain is generated by nodes participating in a multi-party computation scheme and a key management service, according to aspects of the present disclosure.

FIG. 3 illustrates example operations performed by a node participating in a multi-party computation scheme to generate a wallet for transactions on a blockchain, according to aspects of the present disclosure.

FIG. 4 illustrates example operations performed by a management service in a multi-party computation scheme to generate a wallet for transactions on a blockchain, according to aspects of the present disclosure.

FIG. 5 illustrates an example system on which embodiments of the present disclosure can be performed.

FIG. 6 illustrates an example system on which embodiments of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Transactions in cryptocurrency systems may be represented as blocks in a blockchain that track a universe of transactions performed using the cryptocurrency system. In these cryptocurrency systems, processed transactions may not be modified at a later date, thus providing an immutable ledger of the transactions performed using the cryptocurrency system.

Wallets, defined by a private key and public key pair, generally hold assets, such as native or non-native tokens, that can be transferred on a blockchain. In order to perform a transaction on a blockchain, a user generally signs a transaction using a private key associated with a wallet from which assets are being transferred on the blockchain. That is, a transaction generally identifies the assets to be transferred and the public address (or public key) of the transferee wallet to which these assets are transferred, and the transaction is signed using the private key associated with the transferor wallet. Decrypting the signature of the transaction, using the public key associated with the transferor wallet, allows for the transaction to be verified and thus for assets to be transferred from the transferor wallet to the transferee wallet upon verification of the transaction (e.g., by computing nodes participating in processing transactions on the blockchain).

Without access to a private key, thus, users are generally unable to perform transactions on a blockchain because users are unable to sign transactions for public verification by the computing nodes participating in processing transactions on the blockchain. Because access to a private key associated with a wallet grants access to the assets contained in a wallet and allows transactions to be performed with respect to the assets in the wallet, the privacy and security of the private key should be maintained. Various techniques are generally used to preserve access to the private key associated with a user's wallet. For example, users may maintain a record of the private key associated with their wallet in a separate (digital or physical) repository. In another example, because private key addresses are generally long alphanumeric strings which are difficult to remember, various key derivation techniques can be used to aid in the retrieval of the private key associated with the wallet. For example, a multi-word passphrase can be generated and used as an input into a key derivation function in order to generate (or retrieve) the private key associated with a wallet. However, while a passphrase may be less complicated to remember than the private key itself, the passphrase generally includes a sufficient number of words such that users store the passphrase in a separate (digital or physical) repository. Thus, users still maintain a record of the private key associated with their wallet in potentially insecure locations, thus exposing the private key of their wallets and potentially allowing malicious actors access to their wallets and the assets contained therein.

To allow for the generation of wallets usable in transactions performed on a blockchain, hierarchical deterministic wallets may be used. Hierarchical deterministic wallets generally are generated based on a tree of key pairs and addresses having a single seed phrase or key (e.g., a master private key or phrase based on which the master key phrase can be recovered). Generally, wallets generated using hierarchical deterministic techniques may be defined based on keys derived from a master private key and a trapdoor function that allow for derivation of a wallet private key from the master private key but does not allow for derivation of the master private key from a wallet private key. While hierarchical deterministic wallet generation techniques allow for wallets to be easily generated and maintained, hierarchical deterministic wallet generation techniques may be subject to security vulnerabilities associated with maintaining the secrecy of the master private key used to generate wallets as well as the secrecy of private keys associated with any specific wallet generated using hierarchical deterministic wallet generation techniques.

To mitigate security vulnerabilities that may arise from the storage of wallet private keys in one location, multi-party computation techniques may allow for the protection of private keys by sharding a private key into a plurality of private shares that can be combined computationally to generate a wallet address. For example, participating nodes in a multi-party wallet generation scheme can provide their respective private shares to a centralized key management service that uses these private shares to generate a chain code that in turn is used to generate the public and private keys associated with a wallet. Because the chain code used to generate the public and private keys associated with a wallet are generated by a centralized key management service, the centralized key management service represents a single point of failure for security within a blockchain system. If the centralized key management service is compromised, malicious parties can compromise the security of wallets generated via the centralized key management service and thus allow the execution of unauthorized transactions using these wallets, exfiltration of tokens or digital assets from wallets, or the like.

Aspects of the present disclosure provide techniques for improving the security of and ease of access to wallets used to conduct transactions on a blockchain by using multiparty computation techniques. As discussed herein, the nodes participating in a multi-party wallet generation scheme may maintain private shares used to calculate a chain code based on which a wallet is generated and may calculate the chain code based on the exchange of the private share data stored at the nodes participating in the multi-party wallet generation scheme. In some aspects, the chain code calculated by a node in a multi-party wallet generation scheme may be used in deriving a child private share for use in a process for signing a transaction to be performed on the blockchain. In some aspects, a node participating in the multi-party wallet generation scheme can directly generate a wallet using the calculated chain code. By doing so, aspects of the present disclosure may improve the security of distributed wallet generation and transaction signing services in blockchain systems, as compromising a centralized key management service may not compromise the generation of the chain code based on which wallets are generated and wallet private keys are recovered. Each node participating in a multi-party wallet generation scheme can independently generate a wallet and sign a transaction (e.g., based on a master chain code and child private share, such as also based on a salted private share from one or more other nodes), without relying on a centralized key management service to accurately generate the data based on which a wallet is to be generated or a private key associated with a wallet is to be recovered.

### Example Generation of and Access to Wallets in Blockchain Systems Using Salted Private Shares

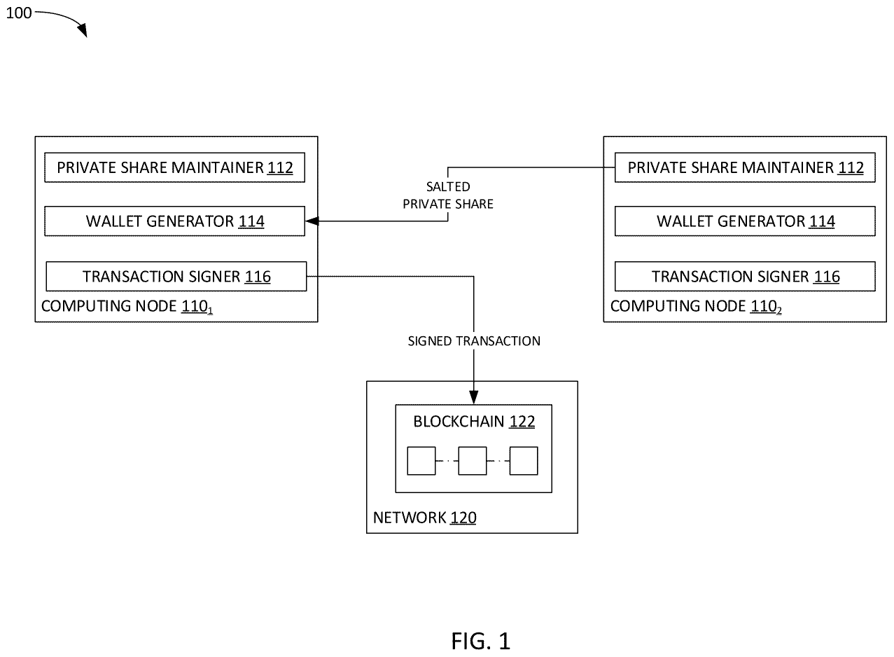

FIG. 1 illustrates an example computing environment 100 in which nodes participating in a multi-party key generation scheme generate a wallet for use in transactions performed on a blockchain. As illustrated, the computing environment 100 includes a plurality of computing nodes 110 and a network 120.

To generate a wallet and/or sign transactions performed on blockchain 122, private shares maintained by a first computing node 110₁ and a second computing node 110₂ can be exchanged. Generally, the private share maintainer 112 can maintain private share data associated with a computing node and which, when combined with private share data associated with another computing node (e.g., which may be “salted” for security, as described in more detail below), allows for performing operations such as signing a transaction that could otherwise only be performed with a private key that has been divided into the private shares. For example, no private key may need to be recovered at all in order to sign a transaction, as the private share data may be combinable in a particular manner, even based on salted shares from other nodes, to perform such operations. To securely share the private share data such that the private share data sk2 associated with a second computing node 110₂ is not revealed to a first computing node 110₁, a salt or other data G may be combined with the private share data associated with the second computing node 110₂. For example, to share the private share data sk2 without revealing sk2 to the first computing node 110₁, the second computing node 110₂ can generate a public share Q₂ based on the private share data sk2 and the salt G. For example, the public share Q₂ may be defined according to the equation Q₂=sk2*G and may thus be a salted version of the private share sk2; because sk2 is multiplied by G, it may be mathematically infeasible to recover the private share data sk2 even if Q₂ is transmitted in the clear.

The wallet generator 114 at the first computing node 110₁ receives the salted private share Q₂=sk2*G from the second computing node 110₂ and uses the salted private share from the second computing node 110₂ and the private share sk1 associated with the first computing node 110₁ to generate a master chain code CC based on which wallet keys are generated and/or recovered. Generally, the master chain code may be associated with a master key based on which wallet private and public key pairs can be derived (e.g., using a trapdoor function that allows for the creation of wallet private and public key pairs but does not allow for the master key to be recovered based on either the wallet private key or the wallet public key). In some aspects, the master chain code CC may be generated according to the equation CC=sk1*Q2=sk1*sk2*G. In some aspects, the master chain code CC may be derived based on a hash function, the private share sk1 associated with the first computing node 110₁, the private share sk2 associated with the second computing node 110₁, and the salt G. For example, the master chain code CC may be represented by the expression: CC=HMAC(sk1*sk2*G, “chain code”), where HMAC represents a hash-based message authentication code function that generates a message authentication code usable in verifying a message represented as the concatenation of sk1*sk2*G (e.g., a shared secret) and the “chain code” message.

Subsequently, the wallet generator 114 at the first computing node 110₁ can generate a wallet (or transaction signer 116 may sign a transaction, as discussed in further detail below) based on the master chain code CC generated from the private share sk1 associated with the first computing node 110₁ and the salted private share Q₂=sk2*G received from the second computing node 110₂. In some aspects, to do so, the wallet generator 114 can generate an intermediate number based on the master chain code CC and a master public key. The master public key may, in some aspects, be based on the private shares sk1 and sk2 and the salt G; for example, the master public key PK may be defined according to the equation PK=(sk1+sk2)*G. Because the first computing node 110₁ and the second computing node 110₂ may have previously agreed upon the salt G, the first computing node 110₁ can compute the master public key as the sum of sk1*G and the salted private share Q2=sk2*G received from the second computing node 110₂.

The resulting intermediate number may subsequently be divided into a delta and a chain code for the wallet being generated or for which a private key is being recovered. For example, the delta may be defined as the first n bits of a binary representation of the intermediate number generated from the master chain code CC and the master public key PK, and the wallet chain code may be defined as the bits after the n^{th} bit of a binary representation of the intermediate number. For example, the delta may be defined as bits 0-31 of the intermediate number, and the wallet chain code CC_{w} may be defined as the 32^{nd} through last bits of the intermediate number. The wallet may subsequently be generated based on the master public and private keys (e.g., defined for a user associated with wallets generated by the computing node 110₁) and the wallet chain code. For example, using elliptic curve key derivation techniques, the master public and private keys may be extended based on the chain code, and the extended master public and private keys, along with an index associated with a wallet, may be used to generate the public and private keys for the wallet. For example, the private key for a wallet generated by the wallet generator 114 may be defined based on a trapdoor function that derives a private key based on the master keys and the index of the wallet. Meanwhile, the public key for the resulting wallet may be generated according to the expression PK+delta*G.

After the wallet generator 114 generates a wallet, the generated wallet may subsequently be deployed for use in performing transactions on the blockchain 122. Generally, the private shares may be used (e.g., by the transaction signer 116) to sign transaction records committed to the blockchain 122, and the public key associated with the wallet may be used to verify transaction records committed to the blockchain 122. In some aspects, to perform a transaction on the blockchain, a user may provide an index of the wallet to the wallet generator 114. In some examples, a management service provides the index of the wallet along with a signing request to one or more computing nodes involved in a signing process for a transaction. The wallet generator 114 can use the provided index, the private share sk₁ associated with the first node 110₁, and a public share (or salted private share) Q₂=sk₂*G associated with the second node 110₂ to generate the wallet (or transaction signer 116 may sign a transaction) using the techniques discussed above.

Network 120 may, in some aspects, be a cryptocurrency network for which computing nodes 110 generate wallets and process transactions. By way of example, network 120 may be a network such as ALGORAND™, BITCOIN™, ETHEREUM®, SOLANA™, STELLAR™, and other cryptocurrency networks. Transactions on a blockchain 122 hosted by network 120 may include, for example, the execution of one or more smart contracts on the blockchain 122 or by the generation of one or more blocks on the blockchain evidencing the occurrence of a transaction on the blockchain 122.

In the computing environment 100 illustrated in FIG. 1, wallet keys may be generated and recovered using a peer-to-peer exchange of secret data between peer computing nodes 110. By using a peer-to-peer exchange of secret data between computing nodes 110, the derivation of chain codes and other sensitive information used as inputs into a key derivation function to generate the wallet used for transactions performed on the blockchain, wallets can be generated locally on a computing node 110₁ without relying on another system to generate the chain code that is used as an input into key derivation functions to generate the wallet.

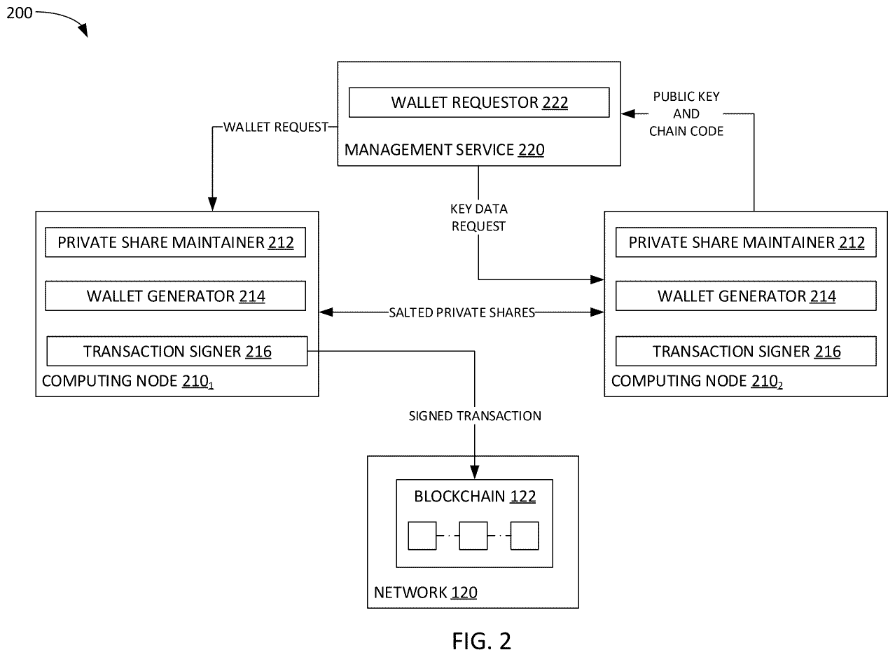

FIG. 2 depicts an example computing environment 200 in which a wallet used for transactions on a blockchain is generated by nodes participating in a multi-party computation scheme and a key management service, according to aspects of the present disclosure. As illustrated, the computing environment 200 includes a first computing node 210₁, a second computing node 210₂, and a management service 220. In the computing environment 200, wallets are generated by one or more computing nodes 210 (e.g., at the request of the management service 220), and to do so in a trustless manner, any given computing node 210 a particular process may be used in which private shares (e.g., including one or more salted private shares from one or more other nodes) are combined without a complete private key ever being derived.

As illustrated, a computing node 210 includes a private share maintainer 212, a wallet generator 214, and a transaction signer 216. The private share maintainer 212 may generally correspond to the private share maintainer 112 illustrated in FIG. 1 and generally maintains private share data (e.g., sk1 for the computing node 210₁, sk2 for the computing node 210₂, a salt G mutually agreed upon for sharing private data between the computing nodes 210₁ and 210₂, etc.).

The wallet generator 214 generally generates a wallet (e.g., based on a request that is transmitted to the computing node 210 from the management service 220 to generate a wallet) based on private data maintained at the computing nodes 210 and/or based on salted private data shared between the computing nodes 210. Generally, to request a wallet, the wallet requestor 222 at management service 220 can transmit a wallet request to a first computing node 210₁, such as including a public key and a chain code associated with a master key based on which wallet private and public keys are derived (or the master public key and the master chain code may be derived by the first computing node 210₁ as explained below), as well as, in some embodiments, a passphrase kk2 that the first component node 210₁ can use to obtain corresponding information from a second computing node 210₂. Alternatively, wallet requestor 222 may use the public key and chain code and/or the passphrase kk2 to obtain corresponding information from the second computing node 210₂, and may provide the corresponding information to the first computing node 210₁. Because the first computing node 210₁ may have knowledge of its own private share sk1 and the shared salt G but may not have knowledge of the private share sk2 associated with the second computing node 210₂, the first computing node 210₁ may request private share data from the second computing node 210₂ (or receive such private share data from management service 220). Likewise, the second computing node 210₂ may have knowledge of its own private share sk2 and the shared salt G but may not have knowledge of the private share sk1 associated with the first computing node 210₁; thus, the second computing node 2102 may request private share data from the first computing node 210₁ (or receive such private share data from management service 220). To preserve the secrecy of the private share data at the computing nodes 210, the private share data may be salted using the shared salt G prior to transmission (e.g., of public share data Qₙ=skn*G, where n corresponds to an index of the computing node 210). For example, the first computing node 210₁ can generate a public share Q₁=sk1*G and transmit the public share Q₁ to the second computing node 210₂, and similarly, the second computing node 210₂ can generate a public share Q₂=sk2*G and transmit the public share Q₂ to the first computing node 210₁. Because the public share (or salted private share) may have an intractably large number of possible factors, the privacy of the private shares sk1 and sk2 may be preserved, as an attacker may not be able to identify the value of the private shares sk1 and sk2 from a factorization of a public share Q associated with the private shares sk1 or sk2.

The first computing node 210₁ may subsequently derive the master public key and master chain code for use in generating a public key for a wallet used in performing transactions on the blockchain 122. The master public key may be represented by the equation PK=(sk1+sk2)*G=sk1*G+sk2*G. Because the first computing node 210₁ may not receive sk2 itself, but instead receive a salted version of sk2 (i.e., Q₂=sk2*G), the public key may be recovered according to the equation PK=sk1*G+Q₂. The master chain code, as discussed above, may be generated based on a product of sk1, sk2, and G (e.g., CC=sk1*sk2*G or CC=HMAC(sk1*sk2*G, “Chain Code”)). In either case, because the public share (or salted private share) Q₂ may be assumed to be equal to sk2*g, the wallet requestor 214 at the first computing node 210₁ may recover the chain code based on a product of sk1 and Q₂. The master public key and master chain code may be reconstructed or otherwise recovered by the second computing node 210₂ using similar techniques.

After the master public key and the master chain code are generated, the first computing node 210₁ generates a a wallet (e.g., including a wallet public key), and the transaction signer 216 can subsequently use the wallet and/or the private share associated with computing node 210₁ (e.g., in combination with a salted private share from computing node 210₂) to sign transaction records committed to the blockchain 122 and use the wallet pubic key to verify transaction records on the blockchain 122.

The management service 220 generally represents a centralized service that may receive master public key PK and master chain code CC information from computing nodes 210 and share such information with other computing nodes 210 for use in defining a wallet on the blockchain 122 based on PK and CC. Generally, to assist generate a wallet at the first computing node 210₁, the wallet requestor 222 at the management service 220 can transmit a key data request to the second computing node 210₂ (assuming, as illustrated, that a wallet is to be generated at the first computing node 210₁) to request PK and CC from the second computing node 210₂. In some aspects, the key data request may include a passcode kk2 associated with an encrypted data store on which the second private share sk2 is stored in an encrypted format. In response, the wallet requestor 222 receives the master public key PK and the master chain code CC from the second computing node 210₂, which may be generated or recovered using the techniques discussed above. Wallet requestor 222 may then send the master public key PK and the master chain code CC from the second computing node 210₂ to the first compuring node 210₁, such as in connection with a request to generate a wallet.

If the master public key PK and the master chain code CC generated at the first computing node 210₁ matches the master public key PK and the master chain code CC received from the second computing node 210₂, the wallet generator 214 can determine that the first and second computing nodes 210₁ and 210₂ have agreed on the underlying data that is to be used in generating the wallet. Thus, the wallet generator 214 can use a key derivation function to generate a public key based on PK and CC. In some aspects, as discussed above with respect to FIG. 1, the key derivation function can append CC to a master key to increase the entropy associated with an input into a key derivation function. The resulting public key, which, as discussed, defines a wallet (e.g., in conjunction with the private shares maintained by computing nodes 210), may be returned to the management service 220 for use in performing and committing transactions involving digital tokens or other assets stored in a wallet to the blockchain 122. Generally, the wallet generator 214 can generate a wallet for use in performing and verifying transactions on the blockchain 122 using similar techniques as those described above with respect to wallet generator 114 illustrated in FIG. 1.

While the example computing environment 200 illustrated in FIG. 2 uses the management service 220 as a central service to assist with generating the wallet at computing nodes 210, the management service 220 does not generate any of the intermediary data used to generate the wallet. Rather, as illustrated, each computing node 210 independently generates the intermediary data (e.g., PK and CC) based on which the wallet is generated. By doing so, critical computations performed during wallet generation may be performed by the computing nodes 210 participating in the wallet generation process, and the wallet requestor 222 can send requests and/or pass information along for use in generating a wallet at a computing node 210 for use on the blockchain based on data provided by the computing nodes 210 in the computing environment 200.

While for simplicity of illustration FIGS. 1 and 2 illustrate the use of two computing nodes to generate a wallet used to perform transactions on the blockchain 122, it should be recognized that any number of computing nodes may hold private share data usable by a node in a computing environment to generate a wallet.

### Example Methods for Generating and Granting Access to Wallets in Blockchain Systems Using Salted Private Shares

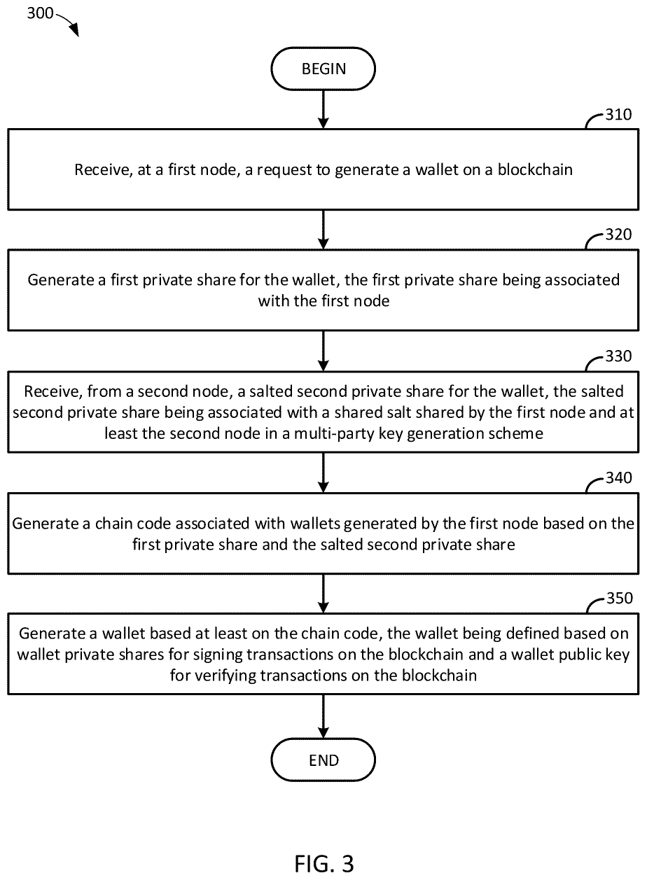

FIG. 3 illustrates example operations 300 performed by a node participating in a multi-party computation scheme (e.g., a computing node 110 illustrated in FIG. 1 or a computing node 210 illustrated in FIG. 1) to generate a wallet for transactions on a blockchain, according to aspects of the present disclosure.

As illustrated, the operations 300 begin at block 310 with receiving, at the first node, a request to generate a wallet on a blockchain.

At block 320, the operations 300 proceed with generating a first private share for the wallet, the first private share being associated with the first node.

At block 330, the operations 300 proceed with receiving, from a second node, a salted second private share for the wallet, the salted second private share being associated with a shared salt shared by the first node and at least the second node in a multi-party key generation scheme.

At block 340, the operations 300 proceed with generating a chain code associated with wallets generated by the first node based on the first private share and the salted second private share.

At block 350, the operations 300 proceed with generating a wallet based at least on the chain code, the wallet being defined based on wallet private shares for signing transactions on the blockchain and a wallet public key for verifying transactions on the blockchain.

In some aspects, generating the chain code may include calculating a product of the first private share and the salted second private share.

In some aspects, generating the chain code may include calculating a cryptographic hash of the first private share and the salted second private share. The chain code may, in some aspects, correspond to a first portion of the cryptographic hash of the first private share and the salted second private share. A delta may correspond to a second portion of the cryptographic hash of the first private share and the salted second private share. For example, the delta may correspond to the first n bits of the cryptographic hash, and the chain code may correspond to the bits after the nth bit in the cryptographic hash. In such a case, generating the wallet may include generating a public key for the wallet based on a master public key calculated as a sum of a salted version of the first private share and the salted second private share, the shared salt, and the delta.

In some aspects, generating the wallet may include retrieving a master key from a management server based on a master public key and the chain code. The wallet may be generated as an output of a key derivation function based on the master key and the chain code. The master key may be retrieved by transmitting a request for the master key to the management server. Generally, the request may include a decryption credential associated with the second private share, a master public key, and the chain code. The master public key and the chain code may be generated, for example, based on the private shares associated with the first and second nodes in a computing environment and a shared salt common to the first and second nodes. The master key may be received in response to trans mitting the request.

In some aspects, generating the wallet may include generating the wallet public key based at least on a master public key and the chain code.

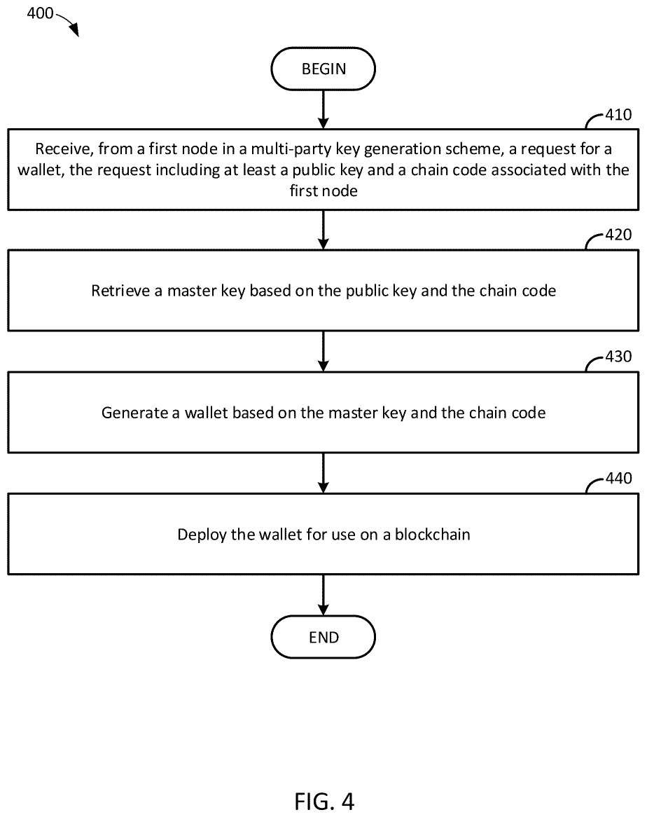

FIG. 4 illustrates example operations 400 performed by a computing node in a multi-party computation scheme (e.g., a wallet generator 214 on a computing node 210 illustrated in FIG. 2) to generate a wallet for transactions on a blockchain, according to aspects of the present disclosure.

As illustrated, the operations 400 may begin at block 410 with receiving, from a first node in a multi-party key generation scheme (e.g., from wallet requestor 222 of management service 220 of FIG. 2), a request for a wallet. Generally, the request includes at least a public key and a chain code associated with the first node, or such information may instead be derived rather than being included in the request. The public key and the chain code may be calculated based on a first private share associated with the first node, a second private share associated with a second node, and a shared salt.

At block 420, the operations 400 proceed with retrieving a master key based on the public key and the chain code.

At block 430, the operations 400 proceed with generating a wallet based on the master key and the chain code.

At block 440, the operations 400 proceed with deploying the wallet for use on the blockchain.

In some aspects, the request further includes decryption credentials for the second node. In some aspects, the operations 400 further include transmitting, to the second node, a request, the request including the decryption credentials for the second node. In response, a management service or the computing node receives, from the second node, a public key and a chain code associated with the second node. In some aspects, the operations 400 further include comparing the public key and the chain code associated with the first node to the public key and the chain code associated with the second node. Based on a comparison indicating that the public key and the chain code associated with the first node to the public key match the public key and the chain code associated with the second node, the master key is retrieved. Generally, the master key is associated with the public key and the chain code associated with the first and the second nodes.

In some aspects, the operations 400 further include based on receiving the request for the wallet, transmitting, to the second node, a request for a public key and chain code associated with the second node. The public key and the chain code associated with the second node are subsequently received from the second node. In some aspects, retrieving the master key includes comparing the public key and the chain code associated with the first node to the public key and the chain code associated with the second node. Based on a comparison indicating that the public key and the chain code associated with the first node to the public key match the public key and the chain code associated with the second node, the master key is retrieved. Generally, the master key is associated with the public key and the chain code associated with the first and the second nodes.

### Example Systems for Generating and Granting Access to Wallets in Blockchain Systems Using Salted Private Shares

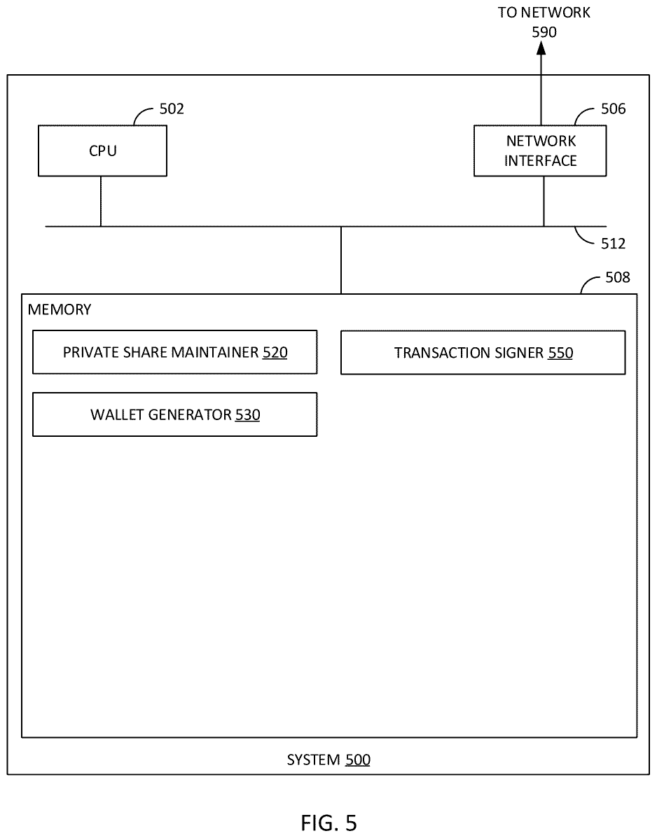

FIG. 5 illustrates an example system 500 configured to perform the methods described herein, including, for example, operations 300 illustrated in FIG. 3. In some aspects, system 500 may act as a computing node that participates in a multi-party key generation scheme in which wallets are maintained and transaction records are signed based on keys associated with a wallet, such as the computing node 110 and/or the computing node 210 illustrated in FIGS. 1 and 2.

As shown, system 500 includes a central processing unit (CPU) 502, network interface 506 through which system 500 is connected to network 590 (which may be a local network, an intranet, the internet, or any other group of computing devices communicatively connected to each other), a memory 508, and an interconnect 512. The network interface 506 may be used to securely exchange private share information and/or wallet information between other nodes participating in a multi-party key generation scheme.

CPU 502 may retrieve and execute programming instructions stored in the memory 508. Similarly, the CPU 502 may retrieve and store application data residing in the memory 508. The interconnect 512 transmits programming instructions and application data, among the CPU 502, network interface 506, and memory 508.

CPU 502 is included to be representative of a single CPU, multiple CPUs, a single CPU having multiple processing cores, and the like.

Memory 508 is representative of a volatile memory, such as a random access memory, or a nonvolatile memory, such as nonvolatile random access memory, phase change random access memory, or the like. As shown, memory 508 includes a private share maintainer 520, a wallet generator 530, a wallet requestor 540, and a transaction signer 550.

The private share maintainer 520 generally corresponds to the private share maintainer 112 illustrated in FIG. 1 and/or the private share maintainer 212 illustrated in FIG. 2. Generally, the private share maintainer 520 maintains a private share sk and a shared salt G that the system 500 uses to generate a public key and chain code based on which a wallet is generated.

The wallet generator 530 generally corresponds to the wallet generator 114 illustrated in FIG. 1. Generally, the wallet generator 530 receives salted private share data from a peer system 500 in a multi-party key generation scheme and uses the salted private share data from the peer system, the private share data maintained by the private share maintainer 520, and the shared salt to generate a public key and chain code. Subsequently, the wallet generator 530 uses the public key and chain code to generate data (e.g., a delta and wallet chain code) that can be used as inputs into a key derivation function to generate the key(s) associated with a wallet on a blockchain.

The transaction signer 550 generally corresponds to the transaction signer 116 illustrated in FIG. 1 and/or the transaction signer 216 illustrated in FIG. 2. Generally, the transaction signer 550 signs a transaction record evidencing a transaction performed using assets associated with a wallet on the blockchain using the private share SK maintained by private share maintainer 520 and one or more salted private shares from one or more other computing nodes, and commits the signed transaction record to the blockchain for verification.

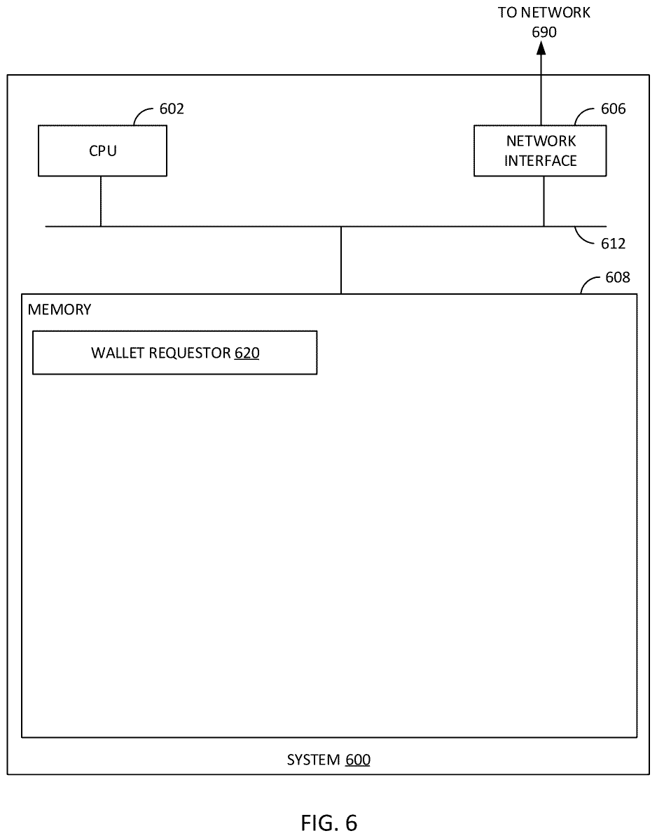

FIG. 6 illustrates an example system 600 configured to perform the methods described herein, including, for example, operations 400 illustrated in FIG. 3. In some aspects, system 600 may act as a management service that participates in a multi-party key generation scheme in which wallets are maintained and transaction records are signed based on keys associated with a wallet, such as the management service 220 illustrated in FIG. 2.

As shown, system 600 includes a central processing unit (CPU) 602, network interface 606 through which system 600 is connected to network 690 (which may be a local network, an intranet, the internet, or any other group of computing devices communicatively connected to each other), a memory 608, and an interconnect 612. The network interface 606 may be used to securely exchange private share information and/or wallet information between other nodes participating in a multi-party key generation scheme.

CPU 602 may retrieve and execute programming instructions stored in the memory 608. Similarly, the CPU 602 may retrieve and store application data residing in the memory 608. The interconnect 612 transmits programming instructions and application data, among the CPU 602, network interface 606, and memory 608.

CPU 602 is included to be representative of a single CPU, multiple CPUs, a single CPU having multiple processing cores, and the like.

Memory 608 is representative of a volatile memory, such as a random access memory, or a nonvolatile memory, such as nonvolatile random access memory, phase change random access memory, or the like. As shown, memory 608 includes a wallet requestor 620.

The wallet requestor 620 generally corresponds to the wallet requestor 222 illustrated in FIG. 2.

### Example Clauses

Implementation details for various aspects of the present disclosure are described in the following numbered clauses.

Clause 1: A processor-implemented method for securely generating wallets on a blockchain by a first node, comprising: receiving, at the first node, a request to generate a wallet on a blockchain; generating a first private share for the wallet, the first private share being associated with the first node; receiving, from a second node, a salted second private share for the wallet, the salted second private share being associated with a shared salt shared by the first node and at least the second node in a multi-party key generation scheme; generating a chain code associated with wallets generated by the first node based on the first private share and the salted second private share; and generating a wallet based at least on the chain code, the wallet being defined based on wallet private shares for signing transactions on the blockchain and a wallet public key for verifying transactions on the blockchain.

Clause 2: The method of Clause 1, wherein generating the chain code comprises calculating a product of the first private share and the salted second private share.

Clause 3: The method of any one of Clauses 1 or 2, wherein generating the chain code comprises calculating a cryptographic hash of the first private share and the salted second private share.

Clause 4: The method of Clause 3, wherein the chain code comprises a first portion of the cryptographic hash of the first private share and the salted second private share, and a delta comprises a second portion of the cryptographic hash of the first private share and the salted second private share.

Clause 5: The method of Clause 4, wherein generating the wallet comprises generating a public key for the wallet based on a master public key calculated as a sum of a salted version of the first private share and the salted second private share, the shared salt, and the delta.

Clause 6: The method of any one of Clauses 1 through 5, wherein generating the wallet comprises: retrieving a master key from a management server based on a master public key and the chain code; and generating the wallet as an output of a key derivation function based on the master key and the chain code.

Clause 7: The method of Clause 6, wherein retrieving the master key from the management server comprises: transmitting a request for the master key to the management server, the request including a decryption credential associated with the second private share, a master public key, and the chain code; and receiving the master key in response to transmitting the request.

Clause 8: The method of any one of Clauses 1 through 7, wherein generating the wallet comprises generating the wallet public key based at least on a master public key and the chain code.

Clause 9: A processor-implemented method for securely generating wallets on a blockchain by a first node, comprising: receiving, from a first node in a multi-party key generation scheme, a request for a wallet, the request including at least a public key and a chain code associated with the first node, the public key and the chain code being calculated based on a first private share associated with the first node, a second private share associated with a second node, and a shared salt; retrieving a master key based on the public key and the chain code; generating a wallet based on the master key and the chain code; and deploying the wallet for use on the blockchain.

Clause 10: The method of Clause 9, wherein the request further includes decryption credentials for the second node.

Clause 11: The method of Clause 10, further comprising: transmitting, to the second node, a request, the request including the decryption credentials for the second node; and receiving, from the second node, a public key and a chain code associated with the second node.

Clause 12: The method of Clause 11, wherein retrieving the master key comprises: comparing the public key and the chain code associated with the first node to the public key and the chain code associated with the second node; and based on a comparison indicating that the public key and the chain code associated with the first node to the public key match the public key and the chain code associated with the second node, retrieving the master key, wherein the master key is associated with the public key and the chain code associated with the first and the second nodes.

Clause 13: The method of any one of Clauses 9 through 12, further comprising: based on receiving the request for the wallet, transmitting, to the second node, a request for a public key and chain code associated with the second node; and receiving, from the second node, the public key and the chain code associated with the second node.

Clause 14: The method of Clause 13, wherein retrieving the master key comprises: comparing the public key and the chain code associated with the first node to the public key and the chain code associated with the second node; and based on a comparison indicating that the public key and the chain code associated with the first node to the public key match the public key and the chain code associated with the second node, retrieving the master key, wherein the master key is associated with the public key and the chain code associated with the first and the second nodes.

Clause 15: A system, comprising: a memory having executable instructions stored thereon; and a processor configured to execute the executable instructions to perform the operations of any one of Clauses 1 through 14.

Clause 16: A system, comprising: means for performing the operations of any one of Clauses 1 through 14.

Clause 17: A computer-readable medium having instructions stored thereon which, when executed by a processor, performs the operations of any one of Clauses 1 through 14.

### Additional Considerations

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A processor-implemented method for securely generating wallets on a blockchain by a first node, comprising:
receiving, at the first node, a request to generate a wallet on a blockchain;
generating a first private share for the wallet, the first private share being associated with the first node;
receiving, from a second node, a salted second private share for the wallet, the salted second private share being associated with a shared salt shared by the first node and at least the second node in a multi-party key generation scheme;
generating a chain code associated with wallets generated by the first node based on the first private share and the salted second private share; and
generating a wallet based at least on the chain code, the wallet being defined based on wallet private shares for signing transactions on the blockchain and a wallet public key for verifying transactions on the blockchain.

2. The method of claim 1, wherein generating the chain code comprises calculating a product of the first private share and the salted second private share.

3. The method of claim 1, wherein generating the chain code comprises calculating a cryptographic hash of the first private share and the salted second private share.

4. The method of claim 3, wherein the chain code comprises a first portion of the cryptographic hash of the first private share and the salted second private share, and a delta comprises a second portion of the cryptographic hash of the first private share and the salted second private share.

5. The method of claim 4, wherein generating the wallet comprises generating a public key for the wallet based on a master public key calculated as a sum of a salted version of the first private share and the salted second private share, the shared salt, and the delta.

6. The method of claim 1, wherein generating the wallet comprises:
retrieving a master key from a management server based on a master public key and the chain code; and
generating the wallet as an output of a key derivation function based on the master key and the chain code.

7. The method of claim 6, wherein retrieving the master key from the management server comprises:
transmitting a request for the master key to the management server, the request including a decryption credential associated with the second private share, a master public key, and the chain code; and
receiving the master key in response to transmitting the request.

8. The method of claim 1, wherein generating the wallet comprises generating the wallet private shares based at least on a master public key and the chain code.

9. A processor-implemented method for securely generating wallets on a blockchain by a first node, comprising:
receiving, from a first node in a multi-party key generation scheme, a request for a wallet, the request including at least a public key and a chain code associated with the first node, the public key and the chain code being calculated based on a first private share associated with the first node, a second private share associated with a second node, and a shared salt;
retrieving a master key based on the public key and the chain code;
generating a wallet based on the master key and the chain code; and
deploying the wallet for use on the blockchain.

10. The method of claim 9, wherein the request further includes decryption credentials for the second node.

11. The method of claim 10, further comprising:
transmitting, to the second node, a request, the request including the decryption credentials for the second node; and
receiving, from the second node, a public key and a chain code associated with the second node.

12. The method of claim 11, wherein retrieving the master key comprises:
comparing the public key and the chain code associated with the first node to the public key and the chain code associated with the second node; and
based on a comparison indicating that the public key and the chain code associated with the first node to the public key match the public key and the chain code associated with the second node, retrieving the master key, wherein the master key is associated with the public key and the chain code associated with the first and the second nodes.

13. The method of claim 9, further comprising:
based on receiving the request for the wallet, transmitting, to the second node, a request for a public key and chain code associated with the second node; and
receiving, from the second node, the public key and the chain code associated with the second node.

14. The method of claim 13, wherein retrieving the master key comprises:
comparing the public key and the chain code associated with the first node to the public key and the chain code associated with the second node; and
based on a comparison indicating that the public key and the chain code associated with the first node to the public key match the public key and the chain code associated with the second node, retrieving the master key, wherein the master key is associated with the public key and the chain code associated with the first and the second nodes.

15. A processing system for securely generating wallets on a blockchain by a first node, comprising:
at least one memory having executable instructions stored thereon; and
one or more processors configured to execute the executable instructions in order to cause the processing system to:
receive, at the first node, a request to generate a wallet on a blockchain;
generate a first private share for the wallet, the first private share being associated with the first node;
receive, from a second node, a salted second private share for the wallet, the salted second private share being associated with a shared salt shared by the first node and at least the second node in a multi-party key generation scheme;
generate a chain code associated with wallets generated by the first node based on the first private share and the salted second private share; and
generate a wallet based at least on the chain code, the wallet being defined based on wallet private shares for signing transactions on the blockchain and a wallet public key for verifying transactions on the blockchain.

16. The processing system of claim 15, wherein to generate the chain code, the one or more processors are configured to cause the processing system to calculate a product of the first private share and the salted second private share.

17. The processing system of claim 15, wherein to generate the chain code, the one or more processors are configured to cause the processing system to calculate a cryptographic hash of the first private share and the salted second private share.

18. The processing system of claim 17, wherein the chain code comprises a first portion of the cryptographic hash of the first private share and the salted second private share, and a delta comprises a second portion of the cryptographic hash of the first private share and the salted second private share.

19. The processing system of claim 18, wherein to generate the wallet, the one or more processors are configured to cause the processing system to generate a public key for the wallet based on a master public key calculated as a sum of a salted version of the first private share and the salted second private share, the shared salt, and the delta.

20. The processing system of claim 15, wherein to generate the wallet, the one or more processors are configured to cause the processing system to:
retrieve a master key from a management server based on a master public key and the chain code; and
generate the wallet as an output of a key derivation function based on the master key and the chain code.

21. The processing system of claim 20, wherein to retrieve the master key from the management server, the one or more processors are configured to cause the processing system to:
transmit a request for the master key to the management server, the request including a decryption credential associated with the second private share, a master public key, and the chain code; and
receive the master key in response to transmitting the request.

22. The processing system of claim 15, wherein to generate the wallet, the one or more processors are configured to cause the processing system to generate the wallet public key based at least on a master public key and the chain code.

23. A processing system for securely generating wallets on a blockchain by a first node, comprising:
at least one memory having executable instructions stored thereon; and
one or more processors configured to execute the executable instructions in order to cause the processing system to:
receive, from a first node in a multi-party key generation scheme, a request for a wallet, the request including at least a public key and a chain code associated with the first node, the public key and the chain code being calculated based on a first private share associated with the first node, a second private share associated with a second node, and a shared salt;
retrieve a master key based on the public key and the chain code;
generate a wallet based on the master key and the chain code; and
deploy the wallet for use on the blockchain.

24. The processing system of claim 23, wherein the request further includes decryption credentials for the second node.

25. The processing system of claim 24, wherein the one or more processors are further configured to cause the processing system to:
transmit, to the second node, a request, the request including the decryption credentials for the second node; and
receive, from the second node, a public key and a chain code associated with the second node.

26. The processing system of claim 25, wherein to retrieve the master key, the one or more processors are configured to cause the processing system to:
compare the public key and the chain code associated with the first node to the public key and the chain code associated with the second node; and
based on a comparison indicating that the public key and the chain code associated with the first node to the public key match the public key and the chain code associated with the second node, retrieve the master key, wherein the master key is associated with the public key and the chain code associated with the first and the second nodes.

27. The processing system of claim 23, wherein the one or more processors are further configured to cause the processing system to:
based on receiving the request for the wallet, transmit, to the second node, a request for a public key and chain code associated with the second node; and
receive, from the second node, the public key and the chain code associated with the second node.

28. The processing system of claim 27, wherein to retrieve the master key, the one or more processors are configured to cause the processing system to:
compare the public key and the chain code associated with the first node to the public key and the chain code associated with the second node; and
based on a comparison indicating that the public key and the chain code associated with the first node to the public key match the public key and the chain code associated with the second node, retrieve the master key, wherein the master key is associated with the public key and the chain code associated with the first and the second nodes.
